(19) United States
(12) Patent Application Publication
(10) Pub. No.: US 2018/0370133 A1
(43) Pub. Date: Dec. 27, 2018

(54) THREE-DIMENSIONAL PRINTER UTILIZING A ROTATING AND TILTING PRINTING SURFACE AND SPIRAL FILAMENT EXTRUSION TO FORM HELICAL FILAMENT STRUCTURES

(71) Applicant: Boston Inventions, LLC, Waltham, MA (US)

(72) Inventor: Samuel David Provencher, Waltham, MA (US)

(73) Assignee: Boston Inventions, LLC, Waltham, MA (US)

(21) Appl. No.: 15/775,089

(22) PCT Filed: Nov. 15, 2016
(86) PCT No.: PCT/US16/62012

§ 371 Date: May 10, 2018

Related U.S. Application Data
(60) Provisional application No. 62/255,554, filed on Nov. 16, 2015.

(51) Int. Cl. B29C 64/245; B33Y 10/00; B33Y 30/00; B29C 64/118; B29C 64/209

(52) U.S. Cl. CPC B29C 64/245; B33Y 10/00; B29C 64/209; B29C 64/118; B33Y 30/00

(57) ABSTRACT

The present disclosure relates to a device and method for additive manufacturing, the device having an extrusion nozzle and a printing surface, wherein the extrusion nozzle is configured to deposit material onto a printing surface, and the printing surface is configured to rotate about a primary axis, the primary axis being normal to a centroid of the printing surface, the printing surface also being tiltable.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### CROSS-REFERENCE TO RELATED APPLICATIONS

This application claims the benefit of the following co-pending application: U.S. provisional patent application No. 62/255,554 filed on Nov. 16, 2015 which is hereby incorporated by reference in its entirety.

### BACKGROUND OF THE INVENTION

### 1. Field of the Invention

The disclosure relates to additive manufacturing, three-dimensional printing, rapid prototyping, and devices for rapidly fabricating tangible models or parts from an amorphous material in contrast to machining from solid materials.

### 2. Description of the Prior Art

Present apparatus for three-dimensional printing typically include heating a filament material within a movable nozzle wherein the methods involve the laying down of successive layers by moving the movable nozzle about a stationary printing surface by using computer controls to translate the nozzle into desired patterns about the stationary printing surface. The computer controls typically involve the use of generating a computer model, and essentially “slicing” the model into a plurality of layers each having a uniform thickness. The computer control then deposits sequential layers of material corresponding in shape to each slice, one upon the other, until a final tangible model or component is produced. These methods can include extrusion deposition, binding of granular materials with heat, lamination, polymerization techniques, as well as other known techniques.

Present methods thus require multiple movement control motors and robust systems which can accurately move a complex nozzle system in numerous planes. It has been recognized that the cost of these movement control motors and control systems increases greatly as the required accuracy and print speeds are simultaneously increased. A large amount of time is wasted in such systems when the motion of the nozzle must be changed, nozzle ejection stopped in order to start a new layer, or there is a natural break in the cross section of the part. Such changes in direction, and starting and stopping of the ejection of material all increase the fabrication or printing time and summarily the cost of the final product.

### SUMMARY OF THE INVENTION

In one aspect of the present invention, it has been recognized that for certain types of objects, namely symmetrical objects having continuous sidewalls, that the efficiency of the process and the machine can be greatly increased resulting in significant improvements in print speeds because the complexity of a three-dimensional printing system can be reduced substantially by reducing the degrees of motion required by the filament nozzle. It has been recognized, that the nozzle itself is a complex system requiring excess structure to move the nozzle, which typically has heating elements and filament feeders attached thereto. Thus, certain advantages are realized by providing a moving printing surface, in particular by providing a rotating printing surface.

In general, motors are relatively good at providing rotational motion, and thus providing rotational systems, and tracking rotational speed is inherently easier and thus can reduce cost. It has then been recognized that co-axial translation, and thus a relative height between the print nozzle and the printing surface, can also be achieved fairly easily by translating a drive shaft supporting, and rotating, the print surface. All of which can aide in simplifying the three-dimensional printing system. In this manner, the print nozzle can be more securely mounted and instead of moving the nozzle in multiple degrees of freedom, can be limited, without limiting potential printable items, by only moving in a single radial direction, i.e. closer to the center of the rotating print surface or further out toward an edge of the rotating print surface. In this manner, any relative point between the rotating print surface and the nozzle can be achieved through a rotation of the print surface, an axial translation of the print surface or a linear and radial translation of the nozzle. In this manner, the required motors for achieving the requisite motion can be attached to robust support systems which reduces complexity while also inherently increasing accuracy. In some instances, additional speed can be achieved by also allowing the nozzle to change a respective height, without overly increasing complexity.

As such, the present invention is illustrated using a three-dimensional printing apparatus which can include an extruder configured to eject a building material so as to form a helical tangible model throughout an additive material process. As discussed above the three-dimensional printing apparatus can further include a printing surface, the printing surface being rotatable about a primary axis being normal from a centroid of the printing surface.

In some embodiments, the printing surface can also be configured so as to allow for tilting out of alignment with a gravitational force, or with respect to the nozzle, or with respect to the primary axis.

It will be appreciated that the printing surface is configured to receive the building material being ejected from the extruder. In some embodiments, the building material can be ejected from the nozzle or extruder continuously, with continuous rotation of the printing surface, such that it forms a helically formed structure, and through continuous extrusion forming the helical tangible model discussed above.

It will be appreciated that as the helical tangible model increases in size that the relative distance between the printing surface and the nozzle will need to increase so as to lay the next pass of the growing helical structure, as such the printing surface can be configured to translate axially along the primary axis so as to vary a relative height between the extruder and the printing surface as the helical tangible model increases in height throughout the additive material process.

As discussed above, in order to print three-dimensional products, the radial distance between the printing surface and the nozzle will also need to change, as such the extruder or nozzle can be configured to translate radially with respect to the primary axis of the printing surface.

In some embodiments, such as wherein the printing surface is configured to tile, some advantage has been recognized wherein the extruder or nozzle has a biased nozzle tip configured to eject the building material at an angle with respect to the printing surface.

It has also been recognized that in certain instances and depending on the desired object being printed or fabricated that multiple materials with varying properties can be part of a particular design, as such in some instances the nozzle or extruder can include a nozzle tip having a plurality of apertures configured to eject a plurality of varying building materials.

As the helical model grows in size it is well understood that the relative height between the nozzle and the printing surface will need to vary so as to account for the growing size of the model, as such the extrusion nozzle can be configured to translate so as to change the relative height between the nozzle or extruder and the printing surface as the tangible model gains a depth, or alternatively the printing surface can be translated axially, or both so as to achieve this translation. In this manner, the efficiency of the process and the machine can be greatly increased resulting in significant improvements in print speeds.

It has also been recognized that tangible models can often adhere to the printing surface, in order to aid in later separation upon completion of the printing process a flexible liner can be provided which can then be disposed over the printing surface, in this manner the liner can be removed and flexed so as to create inflection points and thus separate the liner from the completed object.

In some alternative embodiments, the printing surface itself can be formed of a flexible material. In some such embodiments, an inflection point generator can be provided which can then be configured to deform the printing surface so as to create an inflection point between the printed helical tangible model and the printing surface so as to facilitate separation of the helical tangible model from the printing surface.

In some alternative embodiments, the printing surface can instead be formed from a plurality of interconnected and separable plates forming a segmented platform. Wherein the relative surface area of contact is reduced for each separable plate and thus can reduce the required force necessary to remove the final helical tangible model from the printing surface.

In yet additional embodiments the printing surface can be provided with a connection interface configured to hold and receive one of a plurality of customized build platforms.

Also contemplated herein is a method of additive manufacturing using the devices described herein, the method including the steps of: providing a printing surface configured to both rotate about a central axis, the central axis being normal to and extending from a centroid of the printing surface, the printing surface also being configured to tilt; providing an extruder having an extrusion nozzle; rotating the printing surface; ejecting an additive manufacturing material from the extrusion nozzle onto the printing surface to form a helical tangible model; displacing the extrusion nozzle radially with respect to the central axis of the printing surface; tilting the printing surface about the central axis; and translating either the printing surface or the extruder nozzle in a direction parallel to the axis of rotation so as to increase or decrease the relative distance between the printing surface and the extruder nozzle.

In some alternative embodiments, the method can also include the steps of: translating the extruder nozzle so as to change the relative height between the extruder and the printing surface as the helical tangible model gains a depth; translating the printing surface so as to change the relative height between the extruder and the printing surface as the helical tangible model gains a depth.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-B illustrate top and side views of a rotating printing surface in accordance with various aspects of the present invention;

FIGS. 2A-C illustrate top and side views of a rotating printing surface in accordance with various aspects of the present invention;

FIGS. 3A-E illustrate side cross-sectional views of various helical objects having been printed onto the rotating printing surfaces as shown in FIGS. 1-2 illustrative of various aspects of the present invention;

FIGS. 4A-C illustrate side various views and a partial side zoom view of a nozzle illustrative of a tilting embodiment of the rotating printing surface in accordance with various aspects of the present invention;

FIGS. 5A-B illustrate side views of an exemplary alternative extruder nozzle and its relation to an exemplary printing surface;

FIGS. 6A-B illustrate an end tip view of an alternative extruder nozzle being adaptable for use in the various embodiments discussed herein as well as an end cross-sectional view of a filament being extruded thereby;

FIG. 7 illustrates a top view of an alternative embodiment of a rotating printing surface which utilizes a flexible liner jig;

FIGS. 8A-B illustrate a side cross sectional view of an exemplary assembly of a liner jig and rotating table or base in accordance with the embodiment of FIG. 7;

FIG. 9 illustrates a side cross sectional view of the alternative embodiment of the rotating printing surface of FIG. 7 illustrating an improper method of affixing the liner jig to the rotating table or base;

FIGS. 10A-C illustrate side and top views of a rotating printing surface in accordance with the embodiment of FIG. 7 further illustrating a proper method for affixing the liner jig to the rotating base or table;

FIGS. 11A-B illustrate top cross-sectional views of an exemplary locking system for securing the liner jig to the rotating table;

FIGS. 12A-C illustrate side cross-sectional views of various exemplary liner jigs for attaching to the rotating table;

FIG. 13 illustrates a side cross-sectional view of yet another exemplary embodiment of an alternative rotating base and liner jig configured to implement various aspects of the present invention;

FIGS. 14A-B illustrate side and front views an exemplary roller or inflection point generator adaptable with the various embodiments discussed herein being configured to effectuating the separation procedure using the assembly of FIG. 13;

FIGS. 15A-F illustrate side cross-sectional views of a combination of the separation assembly of FIG. 13 and the roller of FIGS. 14A-B illustrative of various steps for separating a helical structure from the liner jig;

FIG. 16 illustrates a side view of an exemplary manufacturing system utilizing various systems for repetitive manufacturing functions;

FIG. 17 illustrates a side view of yet another exemplary manufacturing system utilizing various systems for repetitive manufacturing functions having additional alternative steps;

FIGS. 18A-B illustrate side cross-sectional views of an alignment system and procedure for ensuring alignment between the liner jig and the rotating table;

FIG. 19 illustrates a top view of an exemplary segmented printing surface;

FIGS. 20A-C illustrate side cross-sectional views of a cam system configured to move the individual segments of the printing surface of FIG. 19;

FIGS. 21A-C illustrate cross-sectional front views of the cam system of FIGS. 20A-C and exemplary mechanisms for effectuating movement of the various segments of the segmented printing surface of FIG. 19;

FIGS. 22A-B front cross sectional views of yet another alternative embodiment of a segmented printing surface further illustrating the actuation of the various components;

FIGS. 23A-B illustrate various side views of yet another embodiment of a rotating printing surface which utilizes an exterior flexible mold system; and

FIGS. 24A-D illustrate various side views of yet another embodiment of a rotating printing surface which utilizes an interior flexible mold system.

### DETAILED DESCRIPTION OF THE PREFERRED EMBODIMENT

Additive manufacturing or three-dimensional printing is a relatively new manufacturing technique having only been developed as recently as the 1980's. The original methods involved the use of applying a thin film of a liquid polymer and using curing or other photo-hardening techniques in order to harden the thin film of liquid polymer representing each slice of the final product, this method was repeated through numerous sequential iterations laying down successive and curing them onto one another until the final product is formed. Almost all of the present rapid prototyping three-dimensional printers still use a method of laying down successive layers or slices, the material used and the bonding techniques between layers is achieved using various methods, but the “slicing” principle has remained somewhat unimproved. Several drawbacks and problems exist in the present methods, in particular these present methods typically involve the moving of nozzles to lay the sequential layers one on top of another. These methods require a gravitational force or curable adhesive to “hold” the present layer onto the existing layer until properly cured, as such it is extremely difficult to create or print features that do not have a supporting layer below them, for example interior voids, shells, overhangs, etc. In addition, because each layer is separate and distinct, the bond between each layer can often be weak. Also, the present methods cause ragged filament layers since the extruder head zigzags back and forth in seemingly erratic fashion which can break or tear the filament as it is being extruded or otherwise ejected from an extruder or nozzle.

The present invention seeks to overcome these and many other deficiencies present in the prior art by providing a three-dimensional printing apparatus 10 having a rotating as well as tiltable printing surface 110 and using an extrusion nozzle 210 configured to print a continuous filament 21 onto the printing surface in a continuous helical fashion rather than breaking the filament in between successive layers or slices.

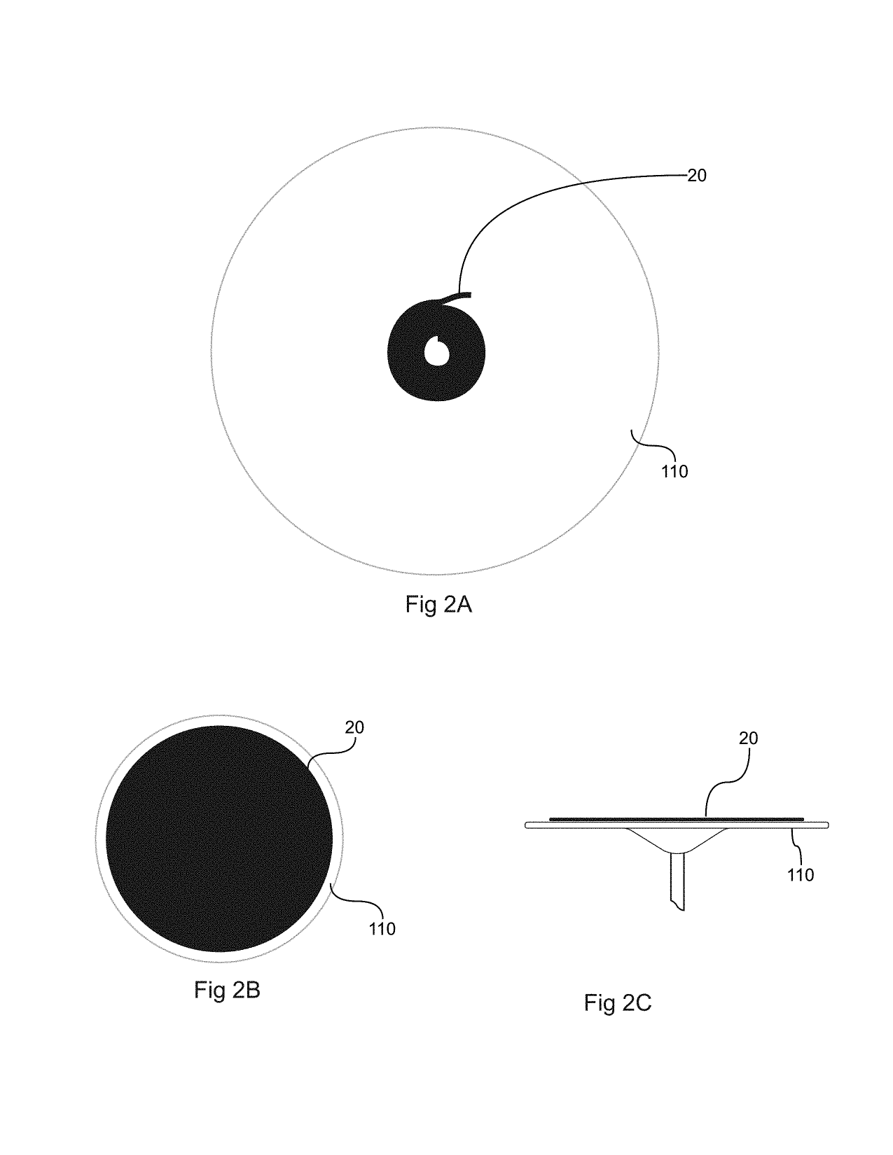

Using the above described printing apparatus the extruder can be used to print a printed object 20, shown herein as a helical tangible model, i.e. a tangible model which is formed of a continuous, or nearly continuous, helical filament 21. This can be achieved by laying a coil of material, or in other words laying a bead of material, into a tight spiral, as illustrated in FIG. 2A, which sticks to itself on successive rings and wherein successive slices or layers are added to one another to increase the depth of the helical tangible model. Also noted is that the extruder nozzle or printing surface can be configured to move axially with respect to the primary axis so as to adjust for the growing height of the helical tangible model. It will be appreciated that in some embodiments once a first coil or layer is completed, the extruder nozzle 210 can translate either toward or away from the printing surface while laying the filament, or alternatively, the printing surface can be actuated so as to change height. The axial movement of the printing surface can be achieved through various means such as a piston on the rotating axis, a screw gear, or some other recognized height adjustment means so as to compensate for the changing height as the coil is laid continuously onto the printing surface.

The present method is of particular advantage when forming round and symmetrical three-dimensional structures, but can also be used to form more complex structures by varying radial distance, rotational speed, and/or interrupting filament extrusion.

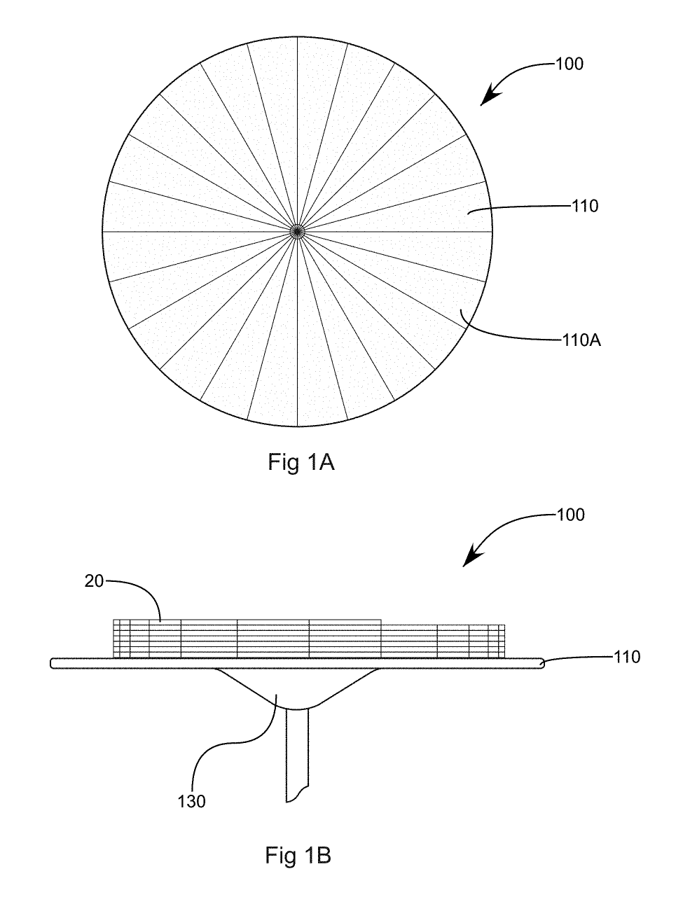

FIGS. 1A-B illustrate top and side views of an exemplary rotating print surface assembly 100 which can include a print surface 110 being affixed to a rotating base 130. It will be appreciated that the print surface 110 can be unitarily or separately formed with the rotating base, however, in some embodiments, as will be discussed in more detail below, in can be of increased advantage to provide a print surface having a plurality of separate segments, as illustrated by 110A.

A helical structure 20 can then be extruded onto the rotating print surface 110. In particular, FIG. 2A illustrates how a filament can be extruded through a nozzle and coiled into a first layer of a three-dimensionally printed object 20 on the print surface 110 so as to form various shapes.

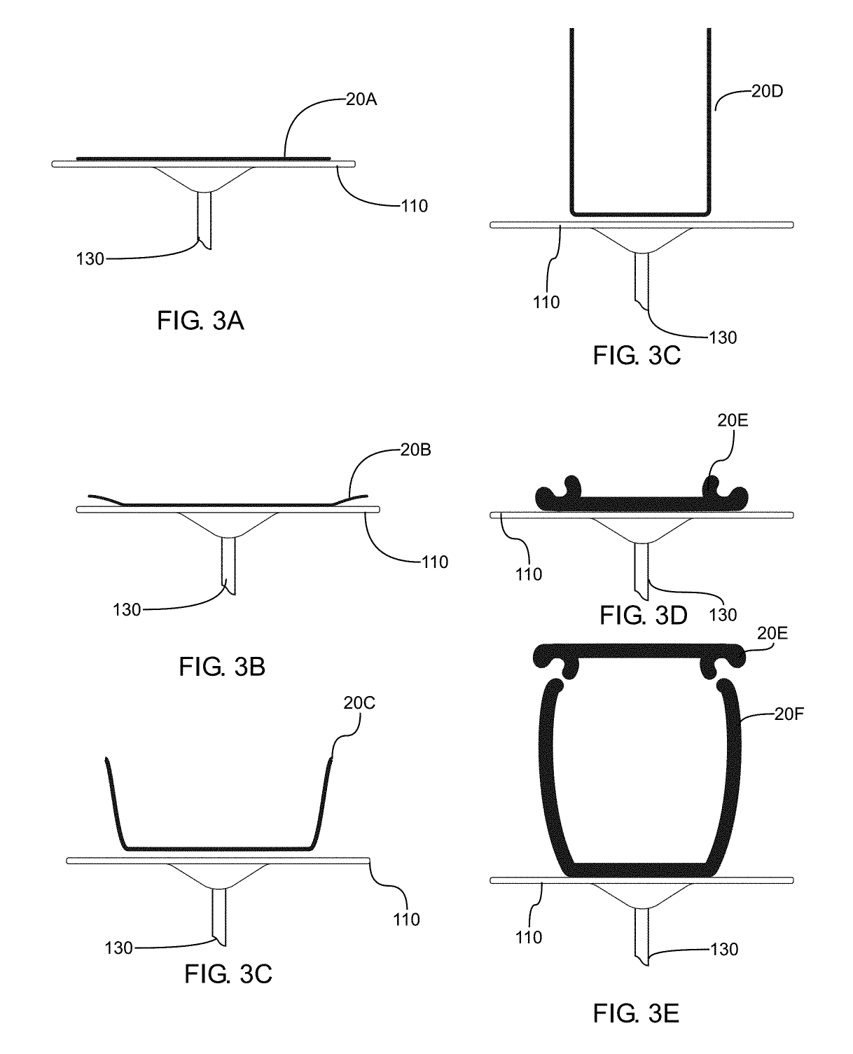

FIGS. 3A-D illustrate various shapes or helical structures 20A-F which can be formed through this helical coiling method. In particular, FIGS. 3D-E illustrate how various helical structures can be formed using this process wherein the various structures can be used in conjunction with each other, such as a lid 20E for a container 20F.

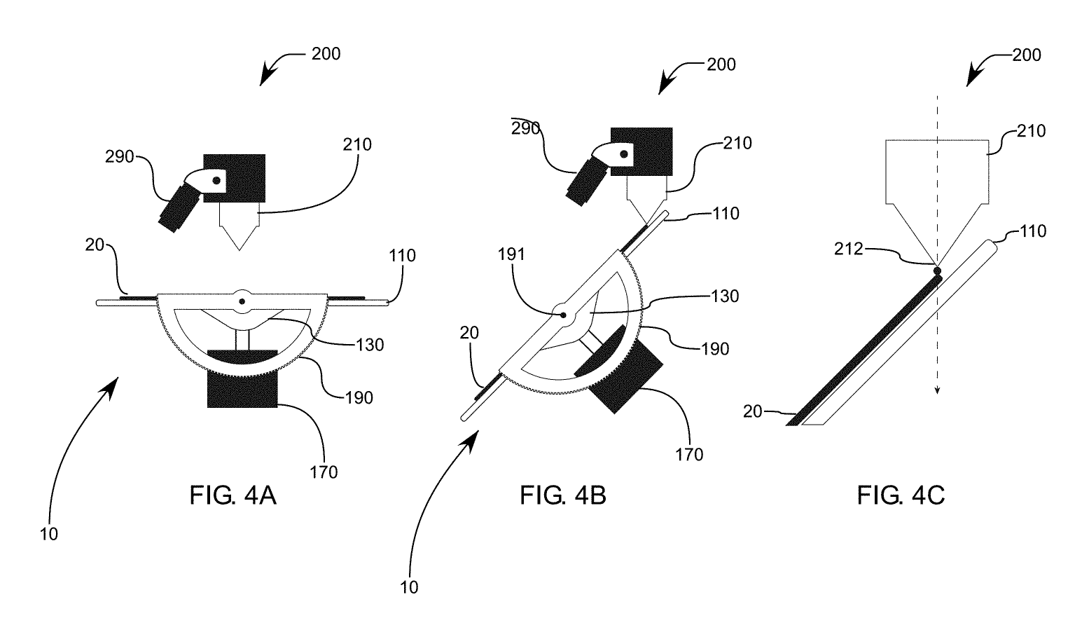

It will be appreciated that some of the structures shown, some of the helical structures include overhanging portions which do not include underlying support. As discussed above, typical three-dimensional printers presently available will be unable to print such overhangs. In order to minimize the problems of not having underlying support, FIGS. 4A-C illustrate how the rotating printing surface 110 can be tilted, such that the next coil of the helix can be applied in a direction being aligned with a gravitational force, wherein the degree of tilt can coincide with the desired angle of the overhanging structure, such as for the plate 20B or bowl 20C of FIGS. 3B-C.

It will then be appreciated that the printing surface 110 can rotate about a primary axis passing through, and being normal to, a centroid of the printing surface. In some embodiments, and as shown in FIG. 4A the printing surface can have a flat orientation wherein the primary axis is normal to the printing surface plane, the primary axis being parallel to a gravitational force. However, the printing surface can also have a tilted orientation, as shown in FIGS. 4B-C wherein the printing surface 110 tilts about a fulcrum 191 being aligned with the primary axis which allows for the printing surface to rotate but the printing surface to be out of alignment with a gravitational force. The tilted arrangement allows for the printing and the existing filament coils thereon to be similarly tilted but form overhangs or other unsupported structures, which is a great limitation of presently available printers. In this manner, the existing or underlying coils can be aligned such that the normal force between the existing coils, as illustrated in FIG. 4C, and the newly extruded filament can be aligned with gravity such that the underlying coils can provide support against the gravitational force until the filament can be cured, dried, or otherwise hardened using, for example, a heater or fan 290.

In some embodiments, the working area can be enclosed so as to form a build chamber. In such embodiments, this build chamber can be configured to also contain a gas or liquid and can even be chilled like a mini-refrigerator so as to cool a hot object quickly.

In yet additional embodiments the model can also be rotated or spun at a high rate of speed. In existing systems, the rate of movement of the printing surface is typically slow or at a low enough rate that the movement is trivial. However, in a high spinning rate embodiment the spin rate can be determined by the object being created as well as the cooling curve of the extruded material. In such an embodiment, a non-trivial rate of speed or spin rate can also cause accelerated cooling. This cooling is caused by what might be referred to as a “Rankine Vortex.” This relates to how vortices form in liquids, which would exclude air normally. In this manner, spinning the model can move the air around it to decrease curing time. Further, in some cases, gravitational alignment might also be compatible with a centrifugal force for some shapes for purposes of aligning coil placement on underlying coils.

It will be appreciated that one or more gear wheels 190 are shown herein which can be utilized to provide the tilting force, however alternative tilting mechanisms can also be utilized. In some embodiments, the rotational motor 170, which is utilized to impart rotation to the rotating surface can be tilted with the rotating print surface 110. However, alternative embodiments utilizing constant velocity joints, etc., could also be utilized to impart rotation from a non-tilting rotational motor.

As discussed briefly above, while the illustrations primarily show circular objects, non-circular objects can also be printed by varying the radial distance of the nozzle 210 while rotating the printing surface 110, i.e. travelling back and forth radially inward and outward. Additional shapes can also be achieved by cutting, during or as a separate step, or by otherwise interrupting the extrusion as the printing surface is rotated. In this manner, using a combination of moving the nozzle, varying rotational speed, or interrupting material ejection or extrusion, various non-circular objects can be similarly fabricated having a generally helical structure.

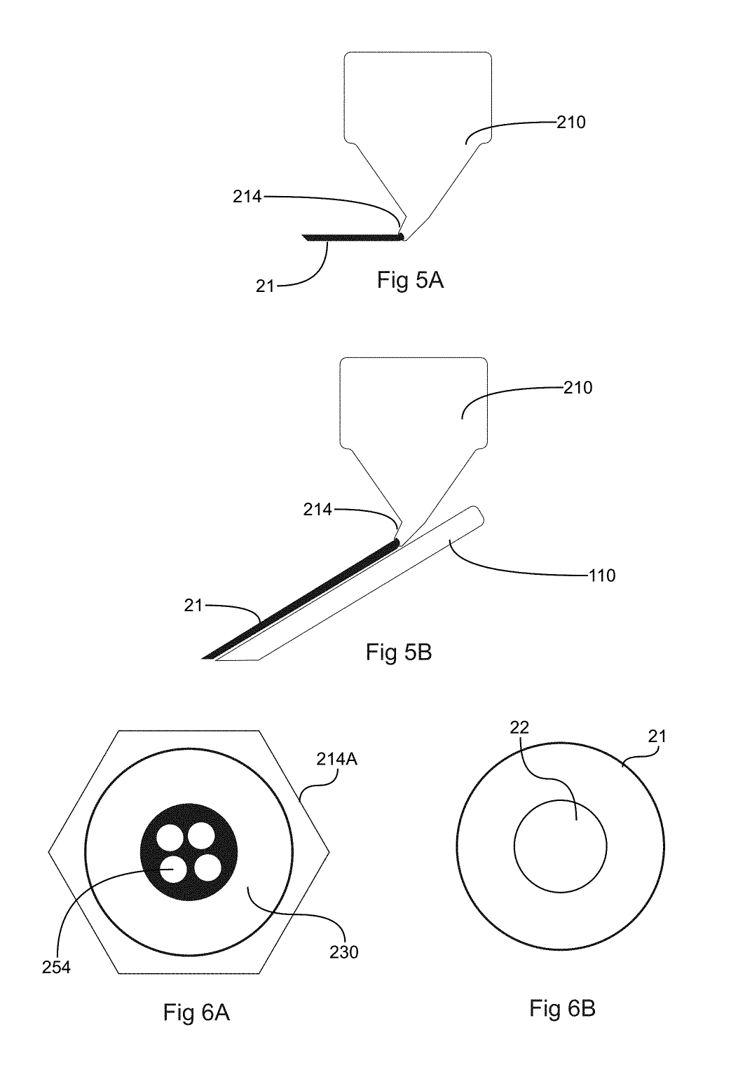

As illustrated in FIGS. 5A-B the extruder or nozzle 210 can include a nozzle tip 214 being configured to eject a filament 21, wherein the filament 21 is used to form the helical structures 20. In some embodiments, and as shown in previous figures, the nozzle can be a symmetrical cone, in yet additional embodiments, and as shown in FIGS. 5A-B the nozzle tip 214 can be angled so as to conform in shape to some degree with the ability of the printing surface 110 to tilt.

In some additional embodiments, and as shown in FIGS. 6A-B a nozzle tip 214A can be provided which is configured to eject a first material through an outer channel 230, and one or more additional materials through the one or more interior channels 254. In this manner, the exterior channel 230 can be configured to extrude the main body of a filament 21, as shown in FIG. 6B, wherein a central portion is either hollow, or can include one or more materials in the central portion 22.

In one embodiment, the filament 21 can be provided with a reinforcing core that is used for strength or some other purpose, similar to high-strength security glass with wire running through it. For purposes of illustration, a high strength wire or cable can be provided along the central portion of the filament to provide additional tensile strength as well as aid in the shape retention of the filament through the curing or hardening process.

It will be appreciated that other reinforcing cores can be used from a simple thread or string to something like a woven cable provided within the filament core.

In an alternative embodiment, instead of providing a reinforcing core, a separate catalytic core can be provided which uses heat as a catalyst, as the core and shell, each of which are provided as different materials, pass through the extruder, the two materials heat up and react either by mixing together, bonding, fusing, or even chemically reacting in some desirable way, and then harden or otherwise cure into the final shape. For example, this might include ejecting the separate components of a hardening resin, such as epoxy, with heat as the catalyst.

In yet additional embodiments, the central core 22 can be hollow, wherein a reactive component, such as chemically reactive or heated gas, can be injected into the core portion of the filament 21 and thus increase the curing speed.

It will be appreciated that in some instances, it can be advantageous to simply print a hollow and tubular structure, such as printing or providing a foam filament, and then using the foam filament to form a cup or bowl, such that the hollow tubular structure with a hollow core 22 can provide some insulative properties, or provide a desired crushing or padding when used to form a desired packaging material around a desired object.

In some embodiments, the printing surface can be provided with one or more features which allow for printed objects to be more easily removed or increase the modularity and thus the potential printing speed of numerous items.

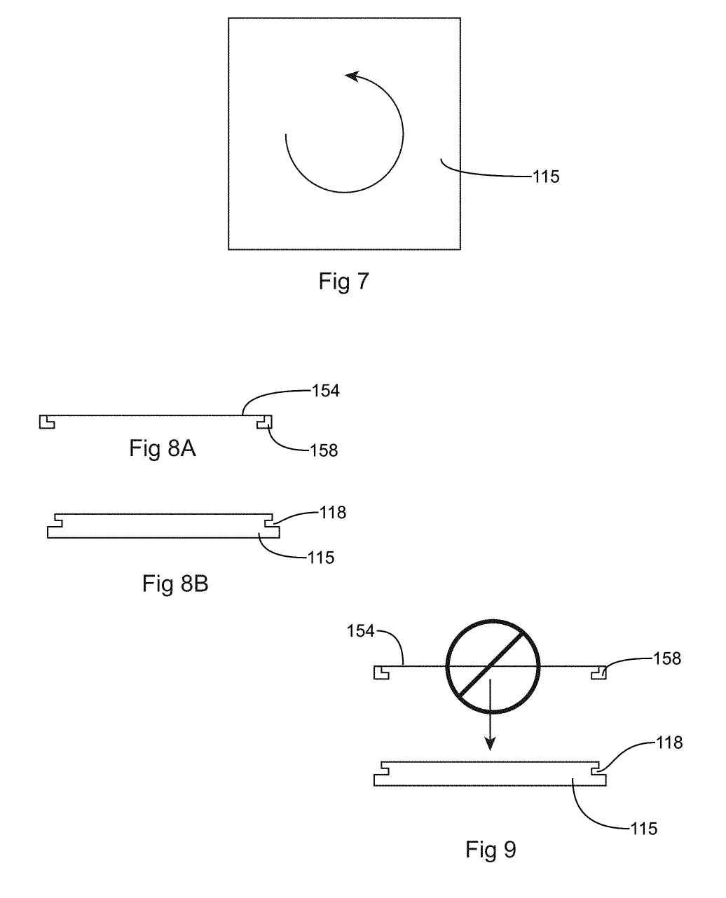

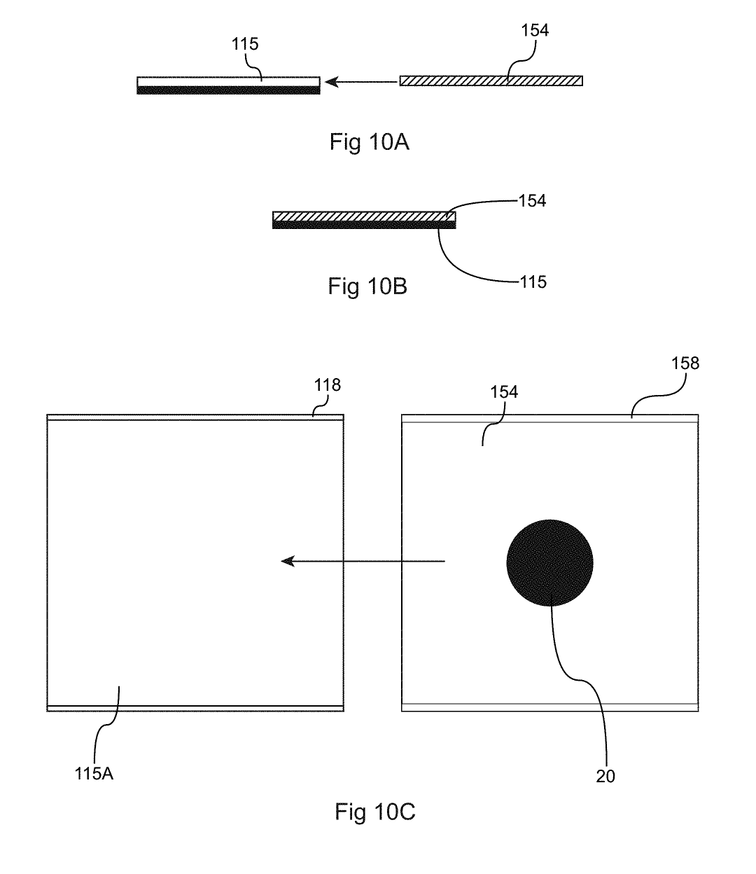

In one embodiment, as shown in FIGS. 7, 8A-B, 9, and 10A-C, a semi-flexible liner jig 154 is contemplated; wherein the flexible liner jig 154 can be elastically deformable but configured to connect to, or otherwise lock to, an inflexible or substantially rigid rotating table 115. As shown, the flexible liner jig 154 can include a plurality of protrusions 158 which interface with and thus connect to a plurality of channels 118 provided in the rigid rotating table 115. In this manner, structural support can be provided to the flexible liner jig so as to add rigidity when locked to the rotating table. It will also be appreciated that the liner jig 154 can be provided by using a keyed system having mating tongue and groove connections between channels provided on one or more surfaces of a movable platform of the printer, wherein corresponding tongues or other mating protrusion keys or channels can be provided on a bottom surface of the liner. Proper alignment can be achieved by ensuring full engagement between the liner and the rotating table by providing an indicator, snap fits, etc., or alignment can be ensured by using laser guides or other camera systems as will be discussed in more detail below.

The purpose of using a flexible jig 154 in a three-dimensional printer is to provide a stable but removable printing surface which follows the part being printed thereon until part completion. This ability of the printing surface to be transferred to several working environments throughout a fabrication process allows for an integrated working area, in particular for parts requiring multiple fabrication steps at various fabrication stations. As such, the semi-flexible liner jig 154 can follow the part through multiple fabrication steps on multiple machines, or working areas, wherein a removal function can be performed remotely from any particular printing or fabrication machine. In this way, a part or component can be printed using the methods described above, but instead of stopping printing while the printed part is removed from the printing surface, the jig can be displaced, and replaced with a new jig, and a new printing operation can be performed while the previous part is removed at a remote location, thus avoiding the printer downtime during the removal process. As such, it will be appreciated that this represents a whole new concept designed to create a similar workflow for three-dimensional printing while solving the issue of automating the removal of a constructed object from a printing surface. By separating the jig from the machine station, we also isolate a primary point of wear in a factory machine. It will be appreciated that this will often be more cost effective to replace the jigs if it extends the service life of the station machinery. Especially if the jigs are designed to take the brunt of the wear.

An additional advantage of the flexible liner jig 154, is that one of the primary difficulties present with many printers generally, is that the removal of printed items is a lengthy or painstaking manual process during which the printing process must be interrupted for undeterminable durations while an already printed item is removed from the printing surface in order to prepare the printing surface for the printing of a new item. This indeterminate timeframe required for manual removal is a major hurdle in the automation of the additive printing process. Additionally, rigid printing surfaces typically have a large surface area of adhered contact between the printed part and the printing surface. As such, the removal process typically requires a heating to near melting, a scraping, or other prying function in order to remove the printed object.

By providing a jig in the form of a semi-flexible liner 154, removal of a part from the surface can be achieved by creating an inflection point along the printing surface so as to effectuate separation between the rigid printed part and the semi-flexible liner. This effectively allows the semi-flexible liner to be peeled away from the printed object after curing is complete. An example of a separation achieved through deflection might include the twisting of an ice cube trays to remove the frozen cubes.

An additional approach is the pipeline approach where each of the pre-printing and setup, printing, and object removal steps are optimized through a modularization of the stages, which modularization can be better realized through the use of the liner jig.

Most existing methods also insist on trying to build the entire part in one stage because they do not have access to a jig system. Such a system means that an object can be manufactured in stages. This can be particularly useful when it is easier to make a shape a certain way and come back for finishing once it has properly set.

One advantage of the flexible liner jig 154, is that it can be removed after the printing process is complete, and moved either to a new work station, for example 115A, which could represent a sanding, or CNC machining process area, etc. or the flexible liner jig could merely be removed to a separation station wherein the flexible liner jig can be deflected so as to aid in the separation of the liner jig 154 from the printed object 20.

Such a jig can also impart texture, printing or other desirable side effects such as a logo or other branding and/or other information which are molded into the product by virtue of the indentations, texture, or recesses provided on the jig.

It will be appreciated that the flexible liner jigs can have contours or other support features which are designed to aid in the curing process and be flexible for easy separation from the final part. However, in this embodiment, the semi-flexible liner is depicted as a thin sheet of flexible material that can be anything having the proper material properties from plastic, to spring steel, or even fabric. The jig will also have rails that run along the side shaped to fit with or otherwise match the grooves in the build plate, such that the top is tight across the top of build plate. It will be appreciated that such a keyed system can keyed to also allow top down insertion with some other locking element or locking motion. In the present embodiment, the jig can be configured so as to require sliding onto the build plate from the side. In the shown embodiment, the rails or channels prevent movement in all but two directions, i.e. sliding on and sliding off. In some alternative embodiments, the jig can be held in place by magnetic attraction, a vacuum, or any other suitable means as will be appreciated by those having skill in the art.

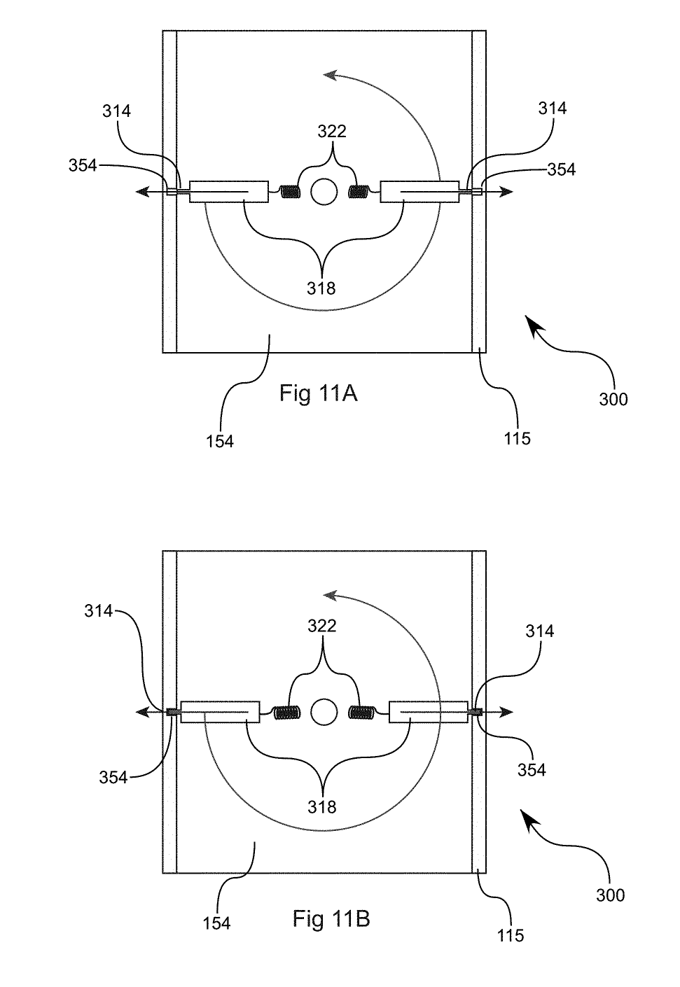

In some additional embodiments, a locking mechanism 300 can be provided so as to ensure that the liner 154 does not slide off during the printing process. In the embodiment shown in FIGS. 11A-11B, a locking pin system can be provided which prevents lateral movement along the rail. In this embodiment, a plurality of locking pins 314 can be provided which correspond to a receiver hole 354 provided in the rotating printing surface 115. The pins 314 can be actuated to lock the relative position of the liner to the platform using centrifugal force created by the spinning build platform. In order to achieve this self-locking, a weight 318 being affixed to a spring 322 can be connected to the pins, wherein as the rotating table spins the weights 318 will overcome the spring force of the spins 322 and cause the pins 314 to enter the holes 354 and into corresponding holes or recesses provided on the liner jig 154. This has the benefit of not needing a mechanism to engage the locks as it uses the rotation of the platform and can be easily tuned for correct operation based on the final rotation speed of the build platform through spring adjustments and/or weights. In such an assembly line style system, wherein each stage can be provided with a particular set of receiving rails. As such, one or more jigs can then be configured to move from station to station. This would be facilitated by the rails of one station, coming into alignment with the rails of the next station, allowing the jig's motion to remain restricted to sliding along the rails. In such an embodiment, each station can then be provided with its own mechanism for locking the jig as appropriate for a particular stage.

The pins can be calibrated to lock the flexible liner to the platform upon reaching a calibrated speed, wherein the rotational speed creates an outward inertial force which overcomes the retraction force of a spring biasing the pins in an unlocked position. The force of the retraction springs keep the pins retracted, i.e. unlocked, when the platform is not rotating.

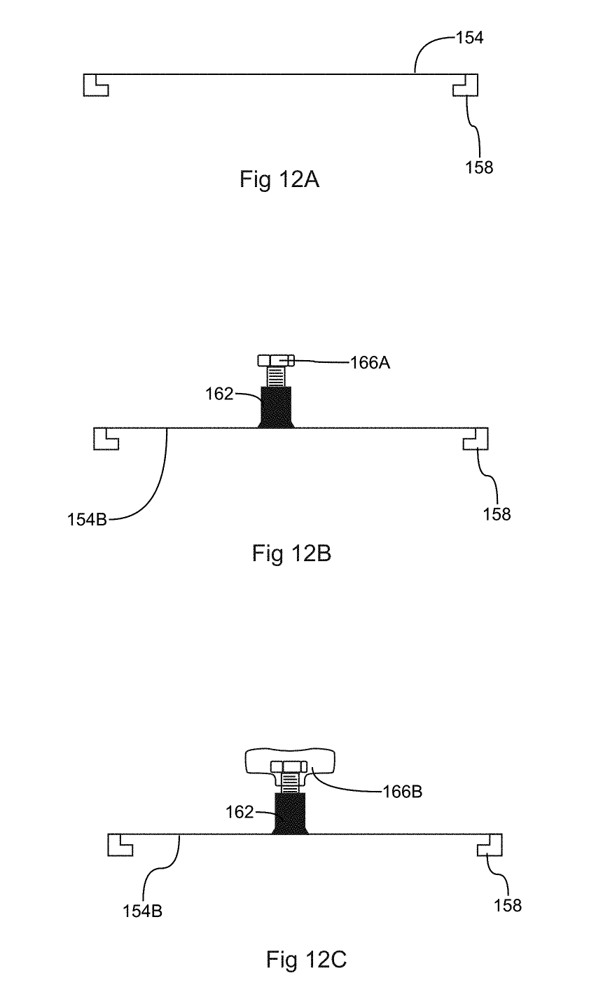

Additionally, once the jig concept is implemented, it opens the door for a jig to be more than a simple flat surface but can be designed to accommodate any number of modifications to build any variety of objects that would be impossible today. As such, the semi-flexible liner jigs can be more than simply a flat, featureless surface, as briefly discussed above, but instead can be printed onto or around particular hardware necessary in the final design. In alternative embodiments, for example as shown in FIGS. 12B-C, a bolt-type jig 154B can be provided wherein the helical object 166B is printed onto the bolt 166A, thus resulting in an overmolded bolt or a helical object which incorporates a portion of the actual printing surface into the final part. It will be appreciated that the interface 162 for connecting an intermediate printing surface can vary in shape, but is shown here as a pedestal having internal female threads. It will be further appreciated that the jig can incorporate any number of potential parts or surfaces in virtually any other jig shape so as to incorporate such into the final printed object.

In yet additional embodiments it is also possible to print structures onto the jig that actually becomes part of the jig, which can be designed to hold something else. An example of such an instance can include providing custom jigs, in essence printing negative structures so as to hold objects where each one has a somewhat different shape.

It will be appreciated that the means by which the user will remove a constructed object can vary depending on the nature of the item. In particular, a separate stage in production can be allowed using different connections or platforms between different processes as determined by the particular factory or components to be manufactured for a “run” of a given object.

It will be appreciated that mechanisms for separating built items from a flexible liner are predicated on an assumption that the printed object has a different rate of elastic or plastic deformation than the semi-flexible liner. The difference in flexibility allows separation to occur by overcoming the adhesion that exists between the object and the liner. Upon removal of the liner from the rotating table, the liner is no longer bound to the rigid build plate. At which point the semi-flexible liner 154 and 154B can be flexed thus creating an inflection point which allows for separation between the printed object and the liner.

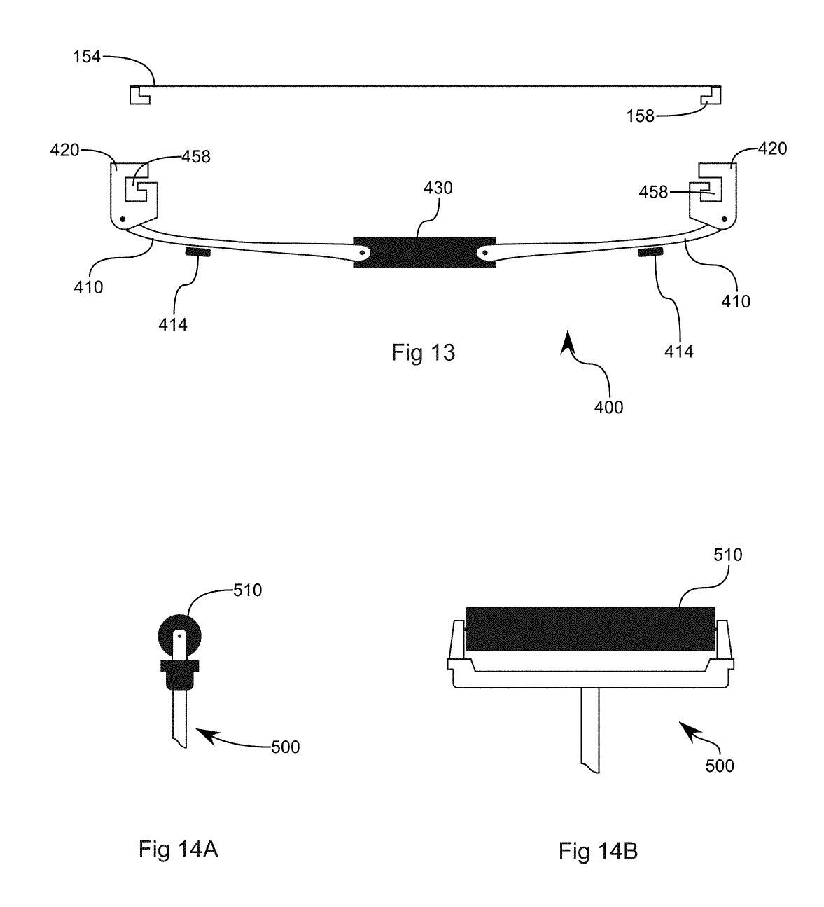

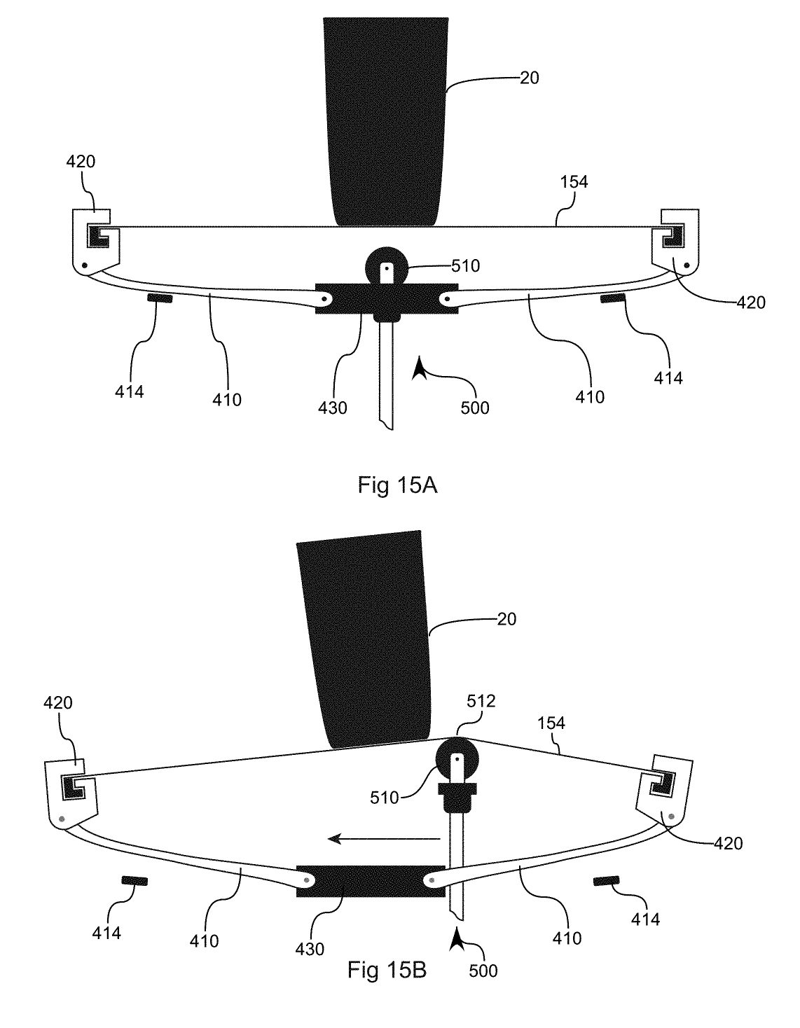

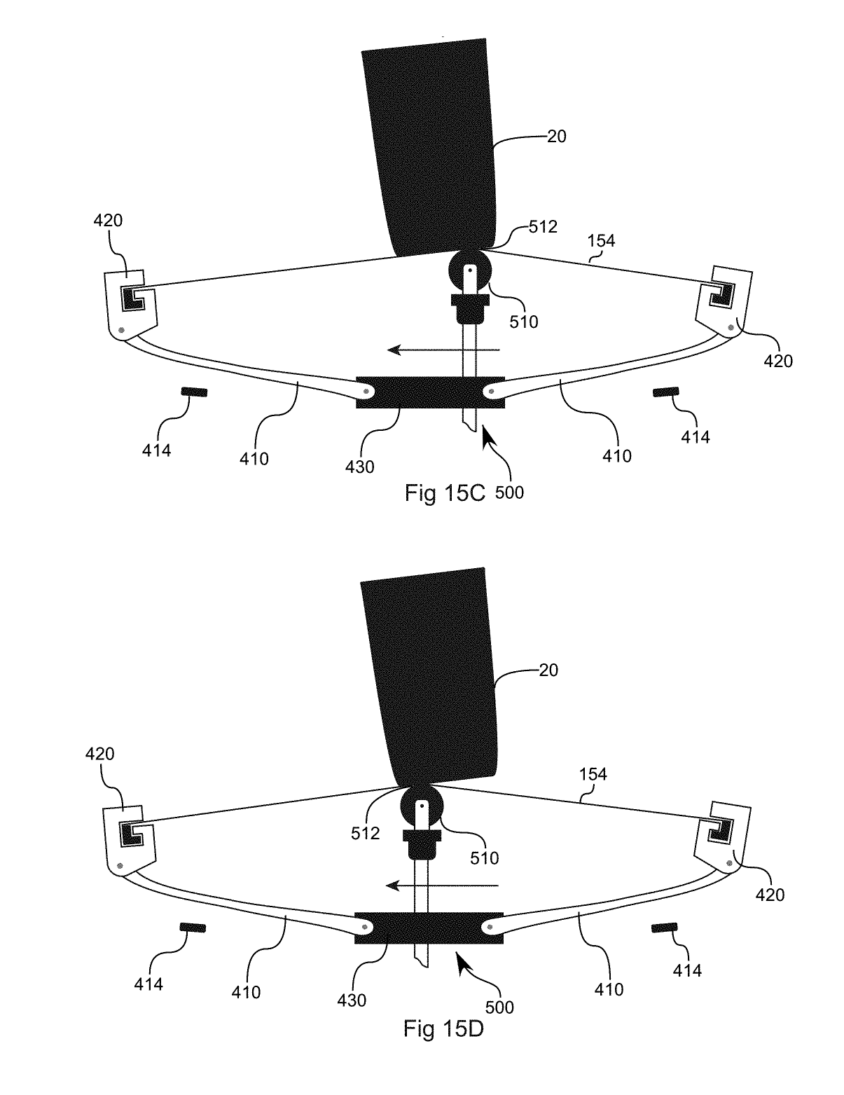

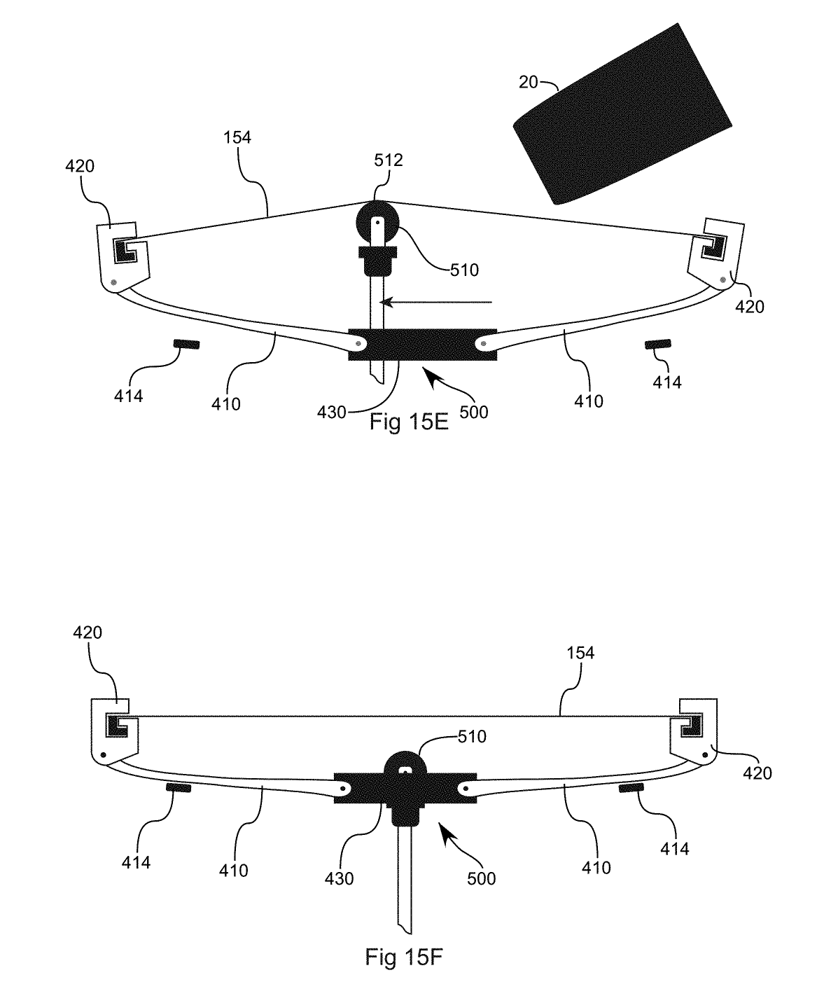

In one embodiment, as shown in FIGS. 13, 15A-F, 16, and 17 the liner jig 154 can be moved to a stage that involves a flex harness 400, the flex harness 400 being designed to execute a very controlled flexing of the liner jig 154 in a manner that will break the adhesive bond in small increments until the entire object is released. This incremental release minimizes stress on the manufactured object that could cause it to lose its structural integrity.

The flex harness 400 can include a rigid base 430 which has a pair of extending arms 410 extending therefrom. The extending arms 410 can then be provided with a liner jig interface 420 having a corresponding channel 458 for holding the protrusions 158 of the liner jig. The liner jig can then be inserted into the channels and the arms extended to rest on stops 414 in a fully extended position. The extending arms 410 can contract and expand so as to hold the liner jig in tension while the roller 510 is moved across the bottom surface of the liner jig 154 so as to create a deflection point. FIGS. 15A-F illustrate a sequential step-by-step process of utilizing the liner jig to create the inflection point 512 and move it along the connected or adhered area between the liner jig 154 and the printed object 20. The flex harness can then include a roller assembly 500 having a roller 510 that is configured to create and move an inflection point along the surface of the liner. By moving the roller 510 to a starting point outside the circumference of the printed object 20, the inflection point 512 is created by deforming the liner jig 154 in an upward direction. The roller 510 can then be moved across the liner jig 154, effectively migrating the inflection point 512 across the area of the liner onto which the constructed object is adhered.

Note that the inflection point 512 is the location that will cause a rigid object to detach on one side or the other from flexible the liner jig 154.

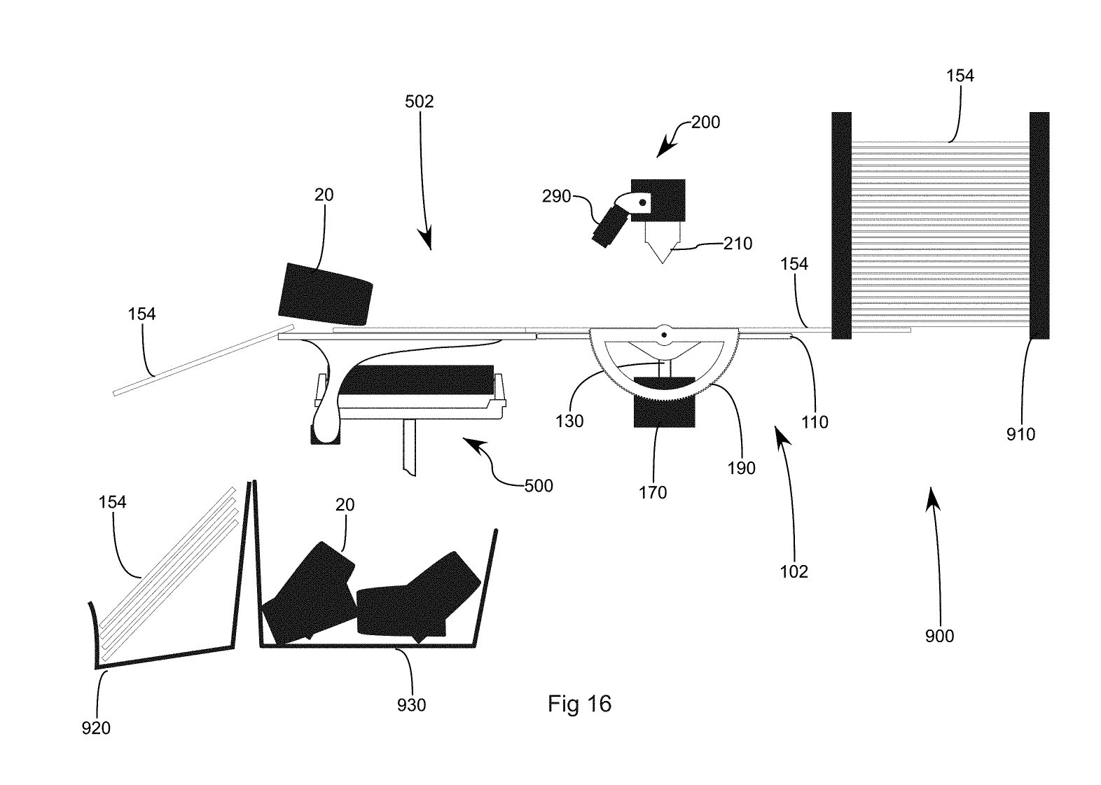

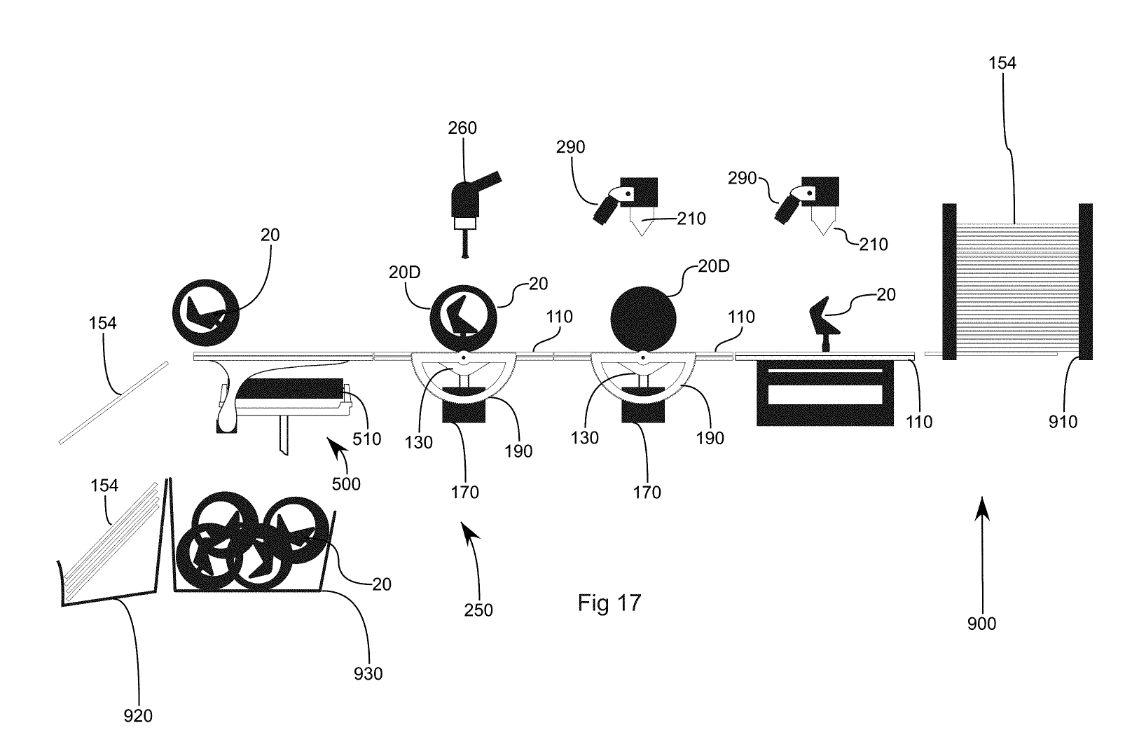

Once you have the base of an object affixed to the liner jig, combined with the ability to lock the liner jig in place on multiple platforms across multiple stages, each stage doing a different thing. As shown in FIGS. 16-17 a modular or stepped process can be implemented with various fabrication steps. A factory can set up any number of modular stages as it sets up for a production run. Leveraging separate stages makes it possible to create complex objects that could not be built in one piece in the past. This can consist of both additive and subtractive stages and the presence of a liner jig keeps all the stages precise and coordinated with each other.

For example, FIG. 16 illustrates the modular system with a separate separation stage 502. The modular system can include a feed system 900 having a supply hopper 910 configured so as to provide a plurality of semi-flexible liners 154 in succession and can be continuously re-stocked after the separation stage 502. Liner jigs 154 can be provided and an object 20 printed thereon in a printing stage 102. This stage also serves to firmly attach the object 20 to the liner jig 154 which will be used throughout any multi-stage processes. Once the object is cured, either naturally or through use of a curing accelerator 290 such as a fan, UV-light, etc., the liner jig with the item can be transferred completely to the separation stage 502 wherein the item is separated into an item hopper 930 and the flexible liners into a liner hopper 920 wherein the liner jigs received thereby are recycled into the supply hopper 910.

For example, FIG. 17 illustrates an alternative modular system which illustrates additional potential complexity by including numerous additive or three-dimensional printing stages as well as a separate machining stage 250. The separate additive printing stages can form complex structures in varying materials or additive material processes, then an object can be finished or otherwise machined using additional tooling 260 such as a CNC bit, which are better suited for certain functions prior to the separation stage 500.

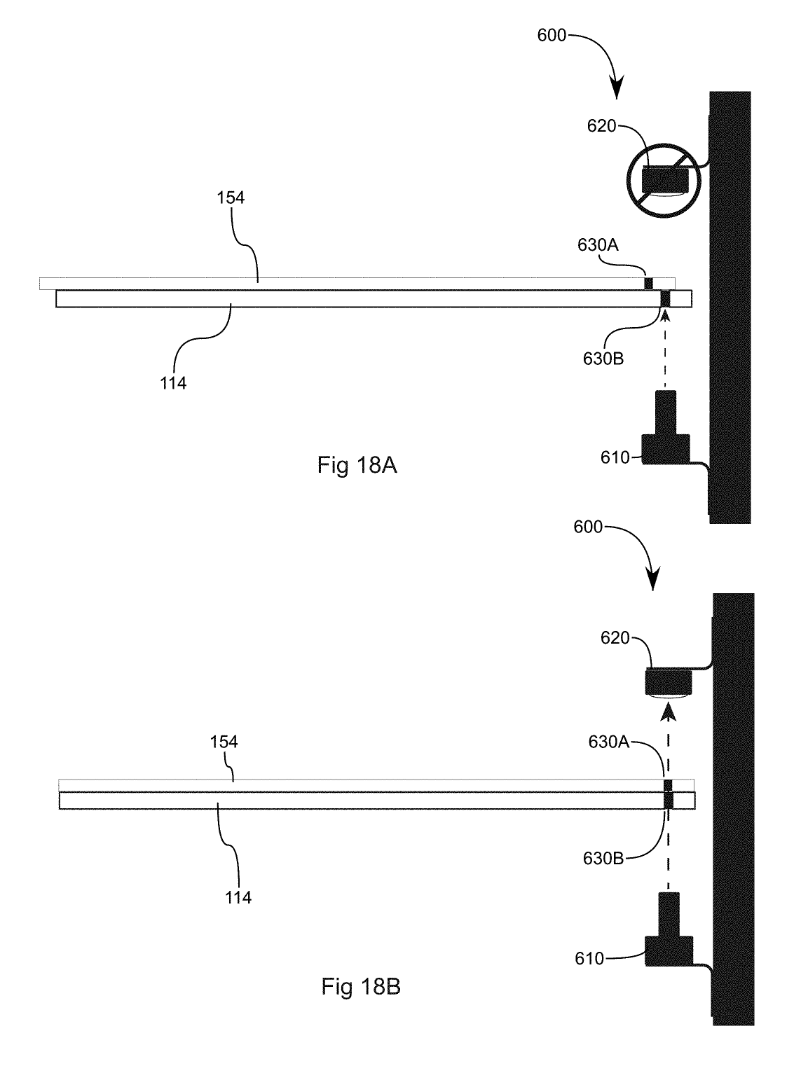

In yet another embodiment, and as shown in FIGS. 18A-B, the alignment between the liner jig 154 and the rotating print surface 114 or other working surface can be ensured through multiple stages with a liner jig 154 that locks to each working station. Detection of proper alignment can be achieved by generating a beam in a laser 610 and directing the laser beam through the holes 630A and 630B provided in respective liner jig 154 and print surface 154 or other working surface and sensing whether the beam travels through to the other side using a receiver 620. It will be appreciated that the design can accommodate as many alignment holes as deemed necessary; for example, two holes provided along a diagonal could be optimal.

In another embodiment of the present invention which overcomes the speed of separation between the printing surface and the printed component or item is achieved by providing a segmented printing surface 700 which is formed of numerous segments 710 being separable from other segments forming the printing surface 700. Each segment 710 of the printing surface can be free to move with respect to other segments of the printing surface 700. It will be understood by those having skill in the art that the adhesive strength of the bond between an item and the surface onto which it is printed is a function of the surface area of the contact patch between the printing surface and the printed object. The printed object being adhered to the surface by virtue of the additive material printing process which typically involves drying or curing and inherently adheres to the surface.

It will be further appreciated that if the contact area can be reduced, the force necessary for separation can thus be reduced. The principle behind the segmented printing surface being that if thin slices or segments 710 can be provided to the printing surface 700, a singular segment can be separated from the printed object in increments at lower forces by individually or independently separating each of the segments in a sequential or alternating fashion between segments until all segments are separated.

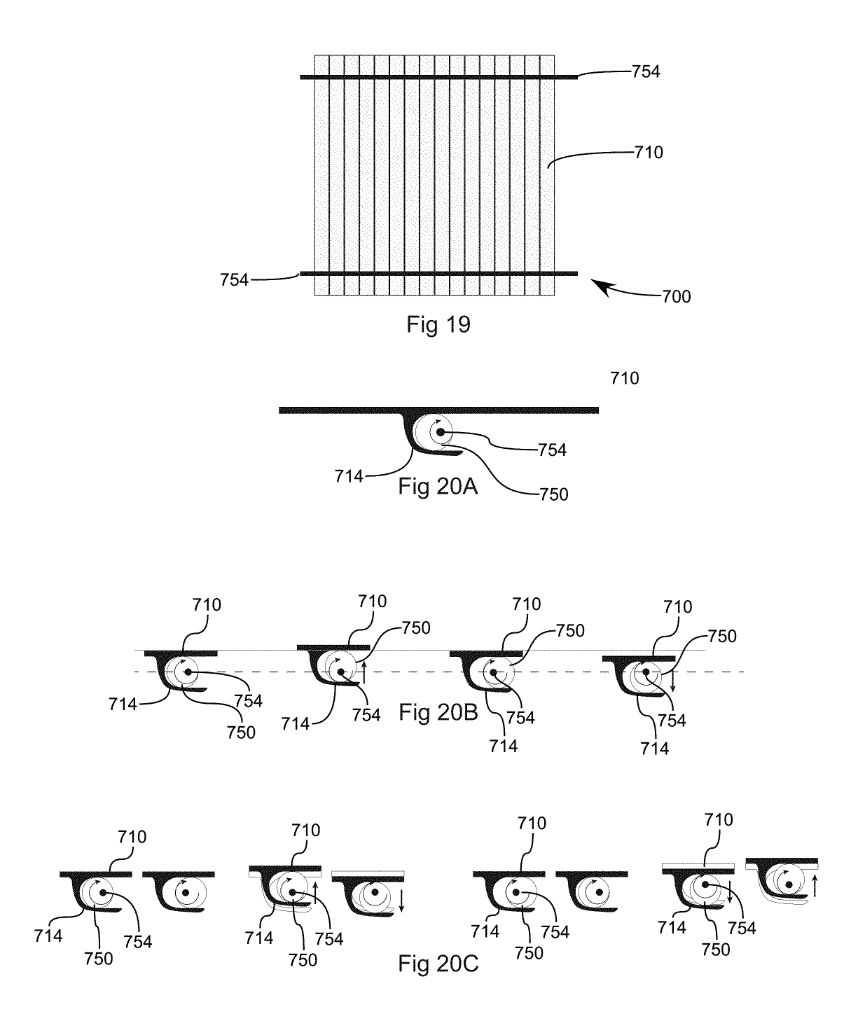

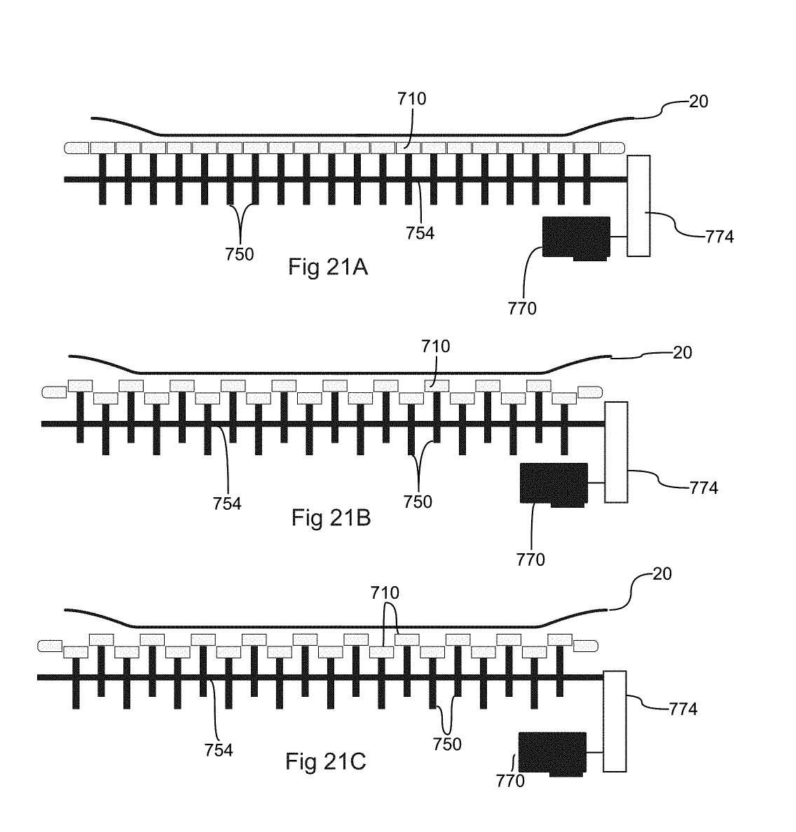

In the embodiments shown in FIGS. 19-22B, a segmented printing surface can be provided; the segmented printing surface can further have a plurality of segments which rest on one or more cams 750 provided in a series of attachment brackets, hooks, or channels 714, each cam rotating on one or more offset cam shafts 754 so as to aid in the separation process. The cam shafts 754 and corresponding cams 750 can operate to pull each of the segments down below a plane being defined by the print surface 700 thus separating a designated segment from the printed object in a particular sequence as desired until all segments have been separated.

The force required is a fraction of the adhesion of the entire object since we are reducing and localizing the separation area to the area of each individual segment 710. As discussed above, the cam can be configured to apply a coordinated downward force on a segment using rotating cam 750 and an attachment bracket 714. This is ideal for a number of reasons: first, the downward force required is a small amount; secondly, the distance downward to break adhesion is also very small, which means that the cams 750 can be small. For this reason, cams mounted on a rotation shaft is sufficient to provide both the forces and distances required, as cam movement is constrained by the difference between the minimum radius and the maximum radius. In this manner, the required force generated by a motor 770 can be greatly reduced and a gear box 774 can further reduce the amount of load between the motor 770 and the force required to spin the cam shaft 754.

For this application, the rotated positioning on the shaft allows for many different sequences and ways to coordinate the downward movement of the segments to balance speed and effectiveness. The benefit being that the diameter of the cam is not constantly changing as its rotation and position changes which allows for the elimination of more complex spring mechanisms and that inherent complexity and leverage both UP and DOWN motion of the cam with a highly-simplified design. In yet additional embodiments, wear on the mechanism can be reduced through the use of bearings on the cams, cam shafts, etc.

Another consideration is sequencing. A cam's traditional shape is designed to allow for complex sequencing, however, for exemplary purposes, we discuss an embodiment having even numbered segments which move downward with respect to alternating odd segments which move upward or remain still thus separating the even segments; then the sequence can be reversed wherein the even segments move UP or remain still with the odd segments moving DOWN thus separating the odd segments. This will effectively free the object as all segments return to a ready or neutral position. All-in-all, every segment will have been lowered and raised one time as the cam shaft executes one full revolution, returning all segments to the ready or neutral position, i.e. flat.

In yet another embodiment a plurality of cam shafts can be placed underneath each end of a given build segment. Doing this helps distribute the force across two cams and places each close to the point where they apply force, effectively minimizing the stress on a particular segment and the mechanism responsible for the transfer of force. Additionally, a two-stage process can be created, where stage one has both cam shafts rotating in concert and a second stage where they are staggered; this would result in applying different separation forces on the constructed object, reducing load on each motor and increasing the reliability of the separation.

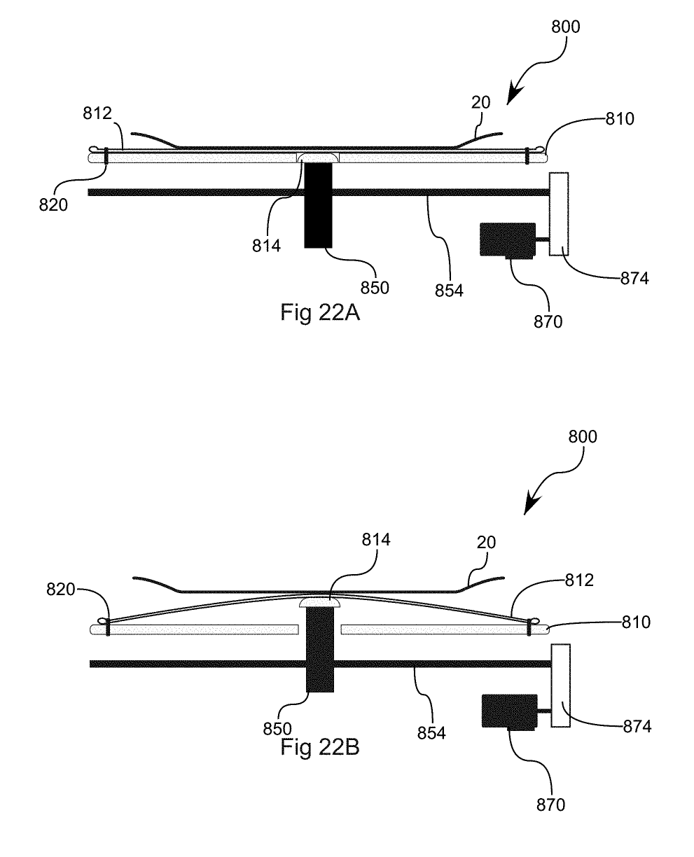

In yet another embodiment, and as shown by FIGS. 22A-B, involves the use of a flexible build platform, along with a lifting cam utilized to cause object separation from the platform on both sides simultaneously. This may not work for some types of objects because a platform of sufficient flexibility could make it unsuitable as a build surface as its ability to flex may cause it to bow and introduce too many irregularities in the precision of location of the build surface. In order to overcome this deficiency, two components can be combined to optimize the capabilities of each: first, a modified build platform 810 for rigidity and stability, and second, provide a thin liner 812, designed for flexibility and coupled with the ability to calibrate the perfect balance of slick-ness and adhesion to a printed object.

Furthermore, to automate this behavior a cam shaft 854, similar to the above-mentioned embodiment, however utilized in a different way. In this embodiment two different pieces can be provided; a rigid build platform with a single center segment 814 which can be shaped and wherein movement of the segment 814 is controlled by movement of a cam 850, in conjunction with and the liner 812. The liner 812 can be configured to have the ability to lie flat or bend in response to upwards force applied to the segment 814 being pushed by the cam 850. It is worth mentioning that the liner 812 is rigid enough to ignore small irregularities like the contours between the segment 814 and the rigid platform 810, this being because downward force is simply the force of extruding soft filament against the liner 812.

As the single cam rises the central segment 814, the liner 812, not attached but held in place by attachment mechanism 820, which could be a clip, clamp, spring clamp, bolt and so forth, which can bend upwards allowing the liner to slide as the cam 850 raises the segment 814. The attachment mechanisms 820 allow the floating liner to slide underneath as upwards pressure causes increased deformation away from a flat plane. This resulting curve will cause the object to separate from the liner as we gradually overcome the adhesive bond; this all occurs in a single rotation of the cam shaft 854 as effectuated by gearing box 874 and motor 870.

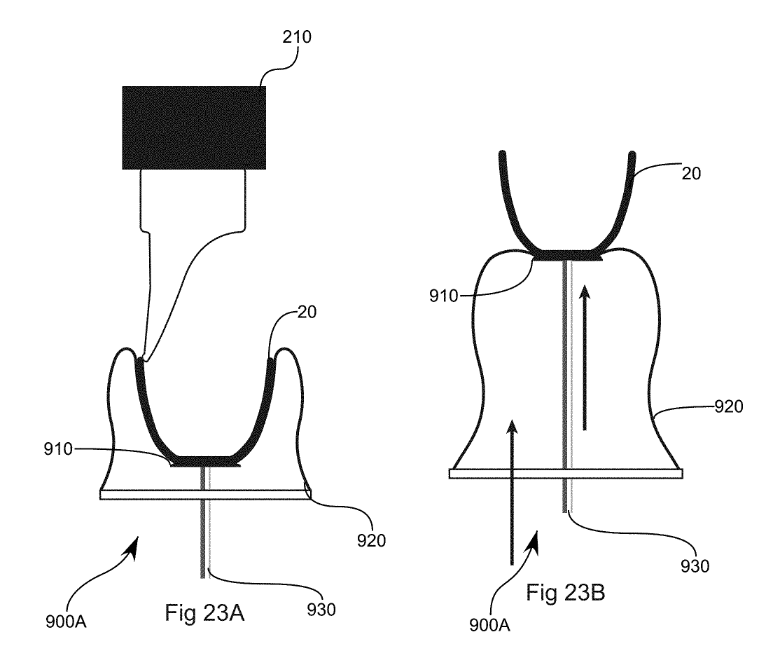

FIGS. 23A-B illustrate the use of yet another embodiment of print system 900A which utilizes a rotating print surface 910 which rotates on a shaft 930. This embodiment differs however, because the print surface is provided with a flexible mold 920 provided about a perimeter edge. The print surface 910 as shown has a reduces cross section and a flexible mold 920 which is configured to provide a degree of lateral support to the overhanging portions of the printed object 200. Once the object is complete, the rotating shaft 930 can be caused to push the print surface 910 in an upward or axial direction so as to peel the flexible mold 920 away from the finished produce, separate the printed object 20 and return to a start position.

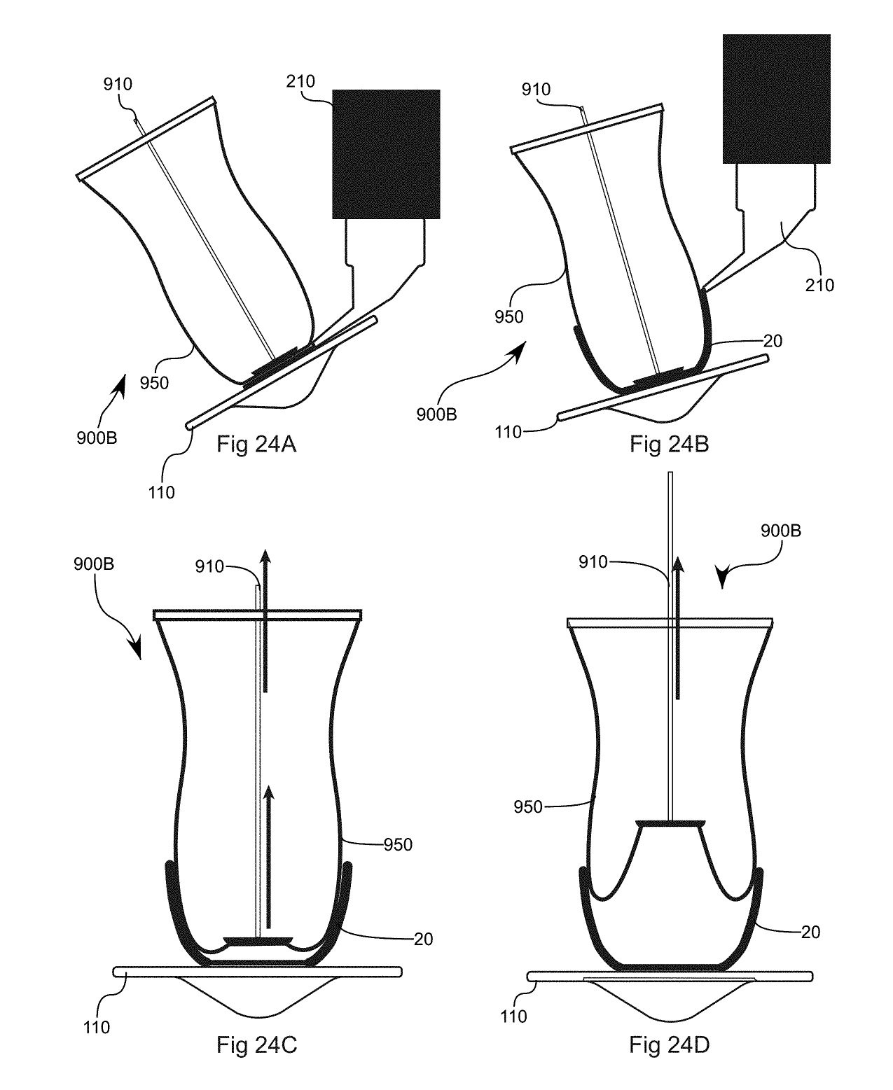

FIGS. 24A-B illustrate the use of yet another embodiment of print system 900B which utilizes a previously disclosed rotating print surface 110, but instead utilizes an interior mold 950. The interior mold 950 can include an extractor rod 940 and an interior mold 950. As illustrated in FIGS. 24A-B the printed object can be printed about an exterior surface of the flexible mold 950 in a suitable manner, which can include tilting the print surface 110 to a certain degree. Once the object is complete the extractor rod 940 can be translated axially thus pulling the flexible form 950 from an interior surface of the finished printed object.

The flexible forms 920 and 950 can be formed of a suitable thin bladder type material having form retention properties and elasticity as will be suitable for a particular object. Additionally, the flexible forms can be configured to be textured or contoured so as to provide a desired contour or texture to the contacting surface of the printed object as the filament is extruded thereon.

Having thus described the various embodiments, various advantages and potential implementations will now be discussed.

As three-dimensional printing increases in reliability and speed it is becoming increasingly commonplace in everyday products and functions. By providing a three-dimensional printer as discussed herein it will be appreciated that the need for stocking various particular items each being formed of similar materials can be reduced by instead printing such items on demand. One example of an implementation includes the use of such a three-dimensional printer in a vending process, for example beverages, soups, or other liquids. Instead of stocking various sizes of plates, cups and bowls which would each be utilized at various rates, the stocking requirement for a particular sized cup or bowl could be eliminated by instead printing a cup or bowl in the desired size and then filling it with a desired liquid. In this manner, the need for stocking various sizes is completely eliminated and instead only a uniform stock printing material, such as a filament or even in pellet form, is needed, which will take up less space and be usable across all container sizes and configurations.

Additionally, particular container characteristics can be changed depending on the intended liquid or another item contained therein. For example, when dispensing heated liquids, such as hot soup or coffee, it might be desirable to create a printed vessel using a hollow filament, such as that shown in FIG. 6B, in order to protect the user's hands from the heat of the liquid contained therein. Similarly, a hollow or insulated filament used in the printing process can also provide insulation to cold beverages to keep them cold for longer. However, for a plate, or other rigid container, or virtually any other type of structural printed object, the structural integrity of the printed object might be more important and thus a reinforced or solid core might be preferable.

Also contemplated herein is a method of utilizing a three-dimensional printing apparatus as described herein to provide packaging material around specific objects. Similar to dispensing machines, a large quantity of storage space and effort goes into obtaining and stocking boxes of specified sizes in warehouses correlating to various sizes of products for later shipment. Instead of requiring a large array of box sizes, a customized container and lid could instead be printed directly around an item using methods and devices described herein. In such a method, a custom container with proper support could be printed at a first station, the item added to the container at a second station and a container lid could be printed and sealed onto the container at a third station. Or alternatively, a flat lid could be printed, an item placed on the lid, and the remainder of the container formed around the item itself thus self-sealing onto the lid in preparation for shipment.

Alternatively, some types of objects might be just as well off if the packing material were printed right on the object, similar to using a form but without the extraction.

In one exemplary embodiment, the filament material can be provided which functions only as an adhesive covering for providing an adhesion layer for sticking one or more components together. In some instances, the filament material can be specifically selected based on formulation or other desired property. For example, biodegradable formulations instead of plastics, or formulations usable in compost or having fertilization which can be specifically selected based on end user preference.

While several embodiments have been described herein that are exemplary of the present invention, one skilled in the art will recognize additional embodiments within the spirit and scope of the invention. Modification and variation can be made to the disclosed embodiments without departing from the scope of the disclosure. Those skilled in the art will appreciate that the applications of the embodiments disclosed herein are varied. Accordingly, additions and modifications can be made without departing from the principles of the disclosure. In this regard, it is intended that such changes would still fall within the scope of the disclosure. Therefore, this disclosure is not limited to particular embodiments, but is intended to cover modifications within the spirit and scope of the disclosure.

What is claimed is:

1. A three-dimensional printing apparatus, comprising:
an extruder configured to eject a building material so as to form a helical tangible model throughout an additive material process;
a printing surface, the printing surface being rotatable about a primary axis being normal from a centroid of the printing surface, the printing surface also being tiltable with respect to a gravitational force, the printing surface configured to receive the building material being ejected from the extruder in the form of a helically formed structure thus forming the helical tangible model; and
wherein the printing surface is configured to translate axially along the primary axis so as to vary a relative height between the extruder and the printing surface as the helical tangible model increases in height throughout the additive material process.

2. The three-dimensional printing apparatus of claim 1, wherein the extruder is configured to translate radially with respect to the primary axis of the printing surface;

3. The three-dimensional printing apparatus of claim 1, wherein the extruder has a biased nozzle tip configured to eject the building material at an angle with respect to the printing surface.

4. The three-dimensional printing apparatus of claim 1, wherein the extruder includes a nozzle tip including a plurality of apertures configured to eject a plurality of building materials.

5. The three-dimensional printing apparatus of claim 1, wherein the extrusion nozzle is configured to translate so as to change the relative height between the extruder and the printing surface as the tangible model gains a depth.

6. The three-dimensional printing apparatus of claim 2, wherein the extrusion nozzle is configured to translate so as to change the relative height between the extruder and the printing surface as the tangible model gains a depth.

7. The three-dimensional printing apparatus of claim 1, further comprising:
a flexible liner disposed over the printing surface.

8. The three-dimensional printing apparatus of claim 1, wherein the printing surface is flexible.

9. The three-dimensional printing apparatus of claim 8, further comprising an inflection point generator configured to deform the printing surface so as to create an inflection point between the printed helical tangible model and the printing surface so as to facilitate separation of the helical tangible model from the printing surface.

10. The three-dimensional printing apparatus of claim 1, wherein the printing surface is formed from a plurality of interconnected and separable plates forming a segmented platform.

11. The three-dimensional printing apparatus of claim 1, wherein the printing surface further comprises a connection interface configured to hold and receive one of a plurality of customized build platforms.

12. An additive manufacturing method, the method comprising the steps of:
providing a printing surface configured to both rotate about a central axis, the central axis being normal to and extending from a centroid of the printing surface, the printing surface also being configured to tilt;
providing an extruder having an extrusion nozzle;
rotating the printing surface;
ejecting an additive manufacturing material from the extrusion nozzle onto the printing surface to form a helical tangible model;
displacing the extrusion nozzle radially with respect to the central axis of the printing surface;
tilting the printing surface about the central axis; and
translating either the printing surface or the extruder nozzle in a direction parallel to the axis of rotation so as to increase or decrease the relative distance between the printing surface and the extruder nozzle.

13. The method of claim 11, further comprising:
translating the extruder nozzle so as to change the relative height between the extruder and the printing surface as the helical tangible model gains a depth.

14. The method of claim 11, further comprising:
translating the printing surface so as to change the relative height between the extruder and the printing surface as the helical tangible model gains a depth.

15. The method of claim 11, further comprising:
providing a plurality of interconnected and separable plates so as to form a segmented printing surface.

16. The method of claim 11, further comprising:
providing a flexible liner disposed over the printing surface.

17. The method of claim 11, further comprising:
deforming the printing surface so as to separate the helical tangible model from the printing surface.

18. A three-dimensional printing system, the system comprising:
a supply of extrudable building material
an extruder configured to extrude the extrudable building material so as to form a helical tangible model;
a printing surface, the printing surface having a deformable portion for receiving the extrudable building material on which the helical tangible model is created, the printing surface being rotatable about a primary axis, the primary axis being normal from a centroid of the printing surface, the printing surface also being configured to tilt with respect to a gravitational force, the printing surface being further configured to receive the building material being ejected from the extruder, wherein the printing surface is configured to translate axially along the primary axis so as to vary a relative height between the extruder and the printing surface; and
a deflection point generator, the deflection point generator being configured to deflect the deformable portion so as to create a movable deflection point which moves along the area on which the helical tangible model is formed onto the deformable portion.

19. The three-dimensional printing system of claim 18, wherein the deformable portion of the printing surface comprises a flexible jig suspended in tension between opposing arms.

20. The three-dimensional printing system of claim 18, wherein the deflection point generator comprises a roller configured to deform the deformable portion.
